(19) United States
(12) Patent Application Publication
(10) Pub. No.: US 2007/0282788 A1
(43) Pub. Date: Dec. 6, 2007

(54) Annotated values

(76) Inventors: Brad Lamb, Pleasant Grove, UT (US); Clark Mitchell, Orem, UT (US); Kirk Lee, Cedar Hills, UT (US); Michael Amore Scalora, Orem, UT (US); David Audley Duncan, Orem, UT (US)

Correspondence Address: GUNNISON, MCKAY & HODGSON, L.L.P., 1900 GARDEN ROAD, SUITE 220, MONTEREY, CA, 93940, US

(21) Appl. No.: 11/416,658

(22) Filed: May 2, 2006

(51) Int. Cl. G06Q 10/00

(52) U.S. Cl. 707/2; 705/1

(57) ABSTRACT

Methods and systems provide for annotating values entered in form fields, and the ability to retrieve the annotations concerning those values. The system and method include a user interface for receiving user input and storing annotations concerning values entered within form fields. The method and system allow for retrieval and editing the annotations previously stored.

### BACKGROUND

The present invention relates to the annotation of values entered in a form, and the retrieval of the annotations.

Users often perform calculations at the time when they enter numeric values in forms. Generally, existing forms only hold, store, and display the values entered. However, users may need to understand the reasoning behind the values after they have been entered. At a later time, a user may be unable to recall how a calculation was performed to arrive at a particular value, or why certain data had been relied upon in performing the calculation.

In addition, information about changes to the calculations over time or by different authors is not commonly stored. In existing forms, a user may not be able to understand the thought process behind the calculations, such as where the data relied upon has changed over time, or where another user originally calculated and entered the value.

### SUMMARY

In various embodiments, the present invention provides methods and systems for annotating values entered in form fields, storing the annotations, and retrieving the annotations concerning those values in response to certain actions by the user. The system and method include a user interface for receiving user input and storing annotations concerning values entered within form fields. The user can then retrieve and edit the annotations previously stored.

The system also provides various methods for triggering the display of a calculation tool that allows for entering annotations. For example, the calculation tool may appear after the user enters a number and an arithmetic operator within a form field. Also, the user may use a selecting tool, such as a mouse or a cursor, to hover over or select a link or an icon within a form field or the form field itself, in order to trigger the display of the calculation tool.

The system further provides for various types of annotations to be associated with values entered into the form fields, as well as the ability to transfer annotated values from other form fields within the same form or other forms. Some examples of annotations include numerals with arithmetic functions, notes, date and author information, an annotated value from a different form field, and a link to a supporting document, such as an email message or invoice.

In addition, the system provides multiple formats for the display of retrieved data in response to user input. For example, a pop up or window may be configured to display simple annotations, such as computations that result in the value, or more detailed notes or author information. Also, certain data may be specified to be hidden from particular users.

In addition, the annotations can have a link to more detailed information, both in a supporting document and within the same application being used. The retrieved data is generally not visible without user input. The user may use a selecting tool, such as a mouse or a cursor, to hover over or select a link or an icon within a form field or the form field itself, in order to trigger the display of the retrieved data.

Thus, the system allows for calculator input of annotations regarding a first value, storage and retrieval of the values and their associated annotations, and a display of the annotations concerning the first value in response to user input.

The description in the specification is not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is a flowchart illustrating a method of entering information about values stored within form fields.

FIG. 2 is flowchart illustrating a method of retrieving information about values stored within form fields.

FIG. 3 is a block diagram illustrating the architecture of one embodiment of a system useful for supporting the method of FIGS. 1 and 2 according to one embodiment of the preset invention.

FIG. 4 is an illustration of one embodiment of a user interface of a financial management software product for requesting a user-manipulable calculation tool.

FIG. 5 is an illustration of another embodiment of a user interface of a financial management software product for requesting for a user-manipulable calculation tool.

FIG. 6 is an illustration of another embodiment of a user interface of a financial management software product for requesting for a user-manipulable calculation tool.

FIG. 7 is an illustration of one embodiment of a user interface of a financial management software product for requesting the creation of a new invoice.

FIG. 8 is an illustration of one embodiment of a user interface of a financial management software product for annotating values.

FIG. 9 is an illustration of one embodiment of a user interface of a financial management software product for requesting an interface to edit to a transaction.

FIG. 10 is an illustration of one embodiment of a user interface of a financial management software product for editing a transaction.

FIG. 11 is an illustration of one embodiment of a user interface of a financial management software product for requesting a form in which to edit a value.

FIG. 12 is an illustration of one embodiment of a user interface of a financial management software product for editing a value.

FIG. 13 is an illustration of one embodiment of a user interface of a financial management software product for requesting a split of a transaction.

FIG. 14 is an illustration of one embodiment of a user interface of a financial management software product for annotating values within a split transaction.

FIG. 15 is an illustration of one embodiment of a user interface of a financial management software product for displaying annotated values within a split transaction.

FIGS. 16A-16C are illustrations of embodiments of a user interface of a financial management software product displaying annotated values.

FIG. 17 is an illustration of one embodiment of a user interface of a financial management software product for specifying whether certain information about certain values is to be displayed.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

According to one embodiment, the present invention provides a user interface for annotating values entered within form fields in a software application. For illustrative purposes, the following description sets forth the invention in the context of a financial software application. However, one skilled in the art will recognize that the techniques described herein can be implemented in other contexts as well.

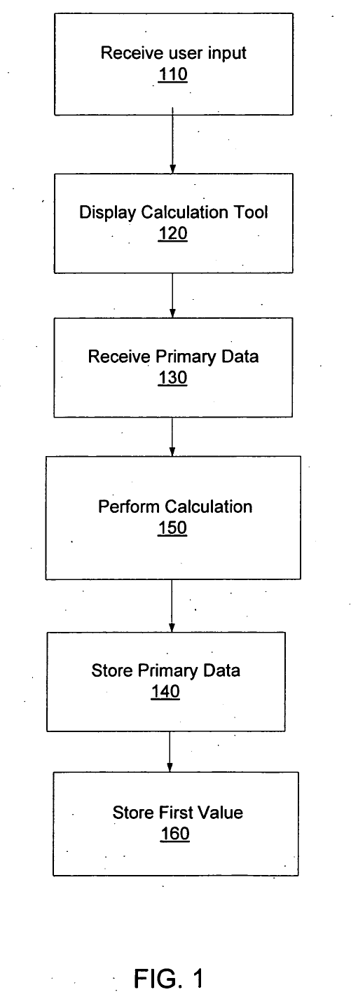

FIG. 1 is a flowchart illustrating a method for annotating values within a form field in a personal financial software application according to one embodiment of the present invention.

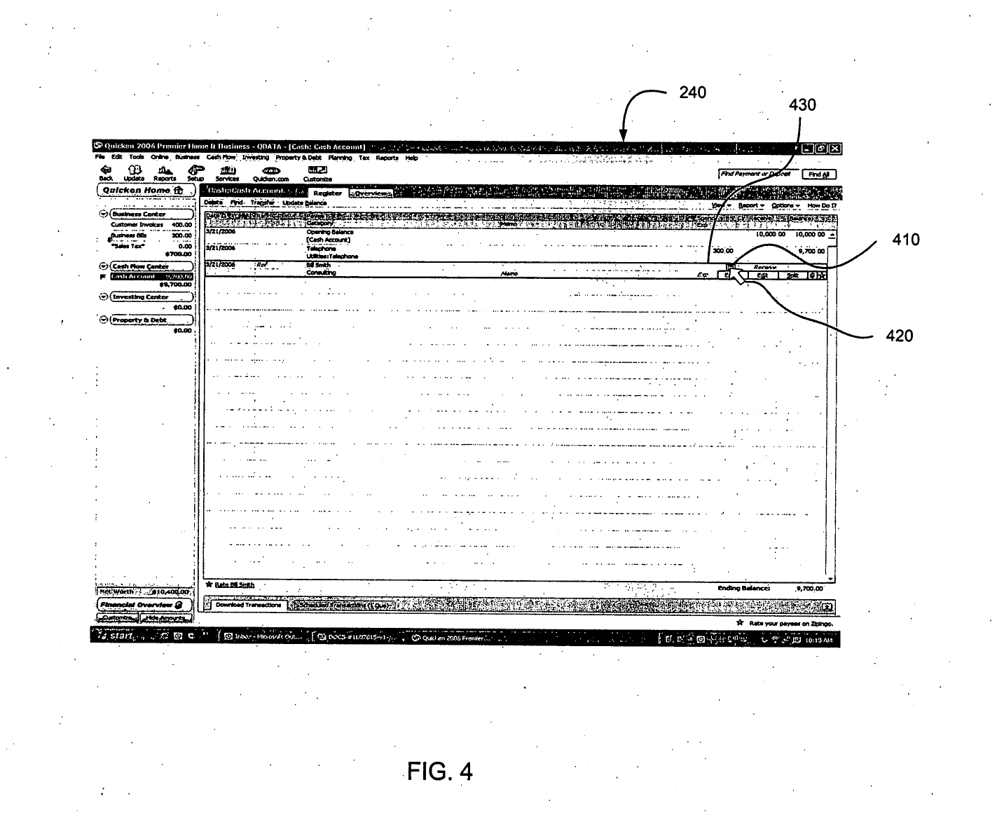

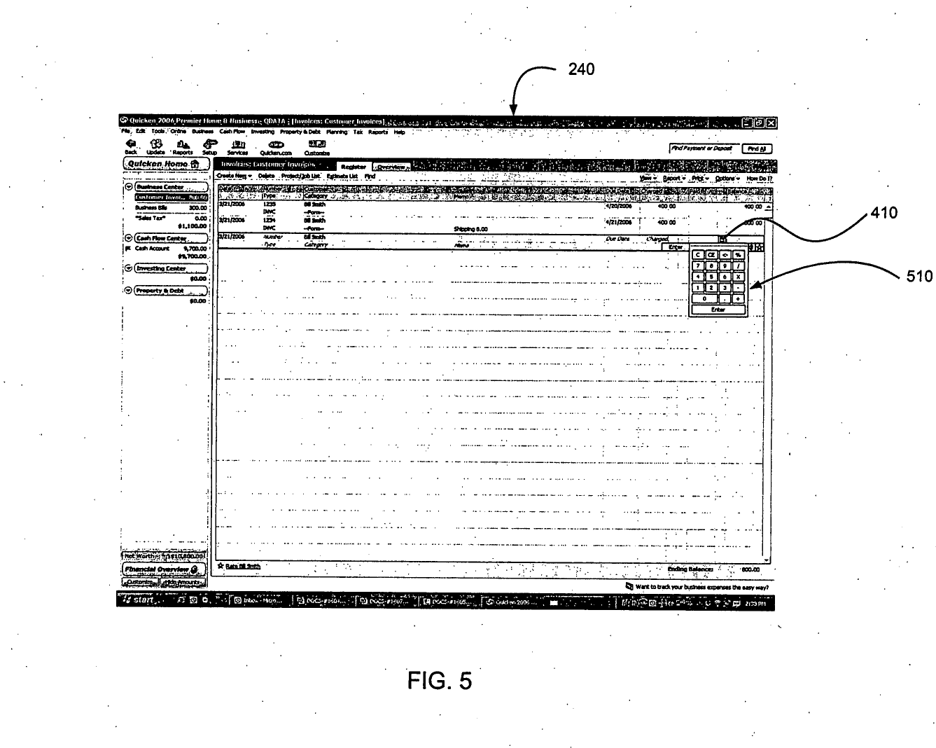

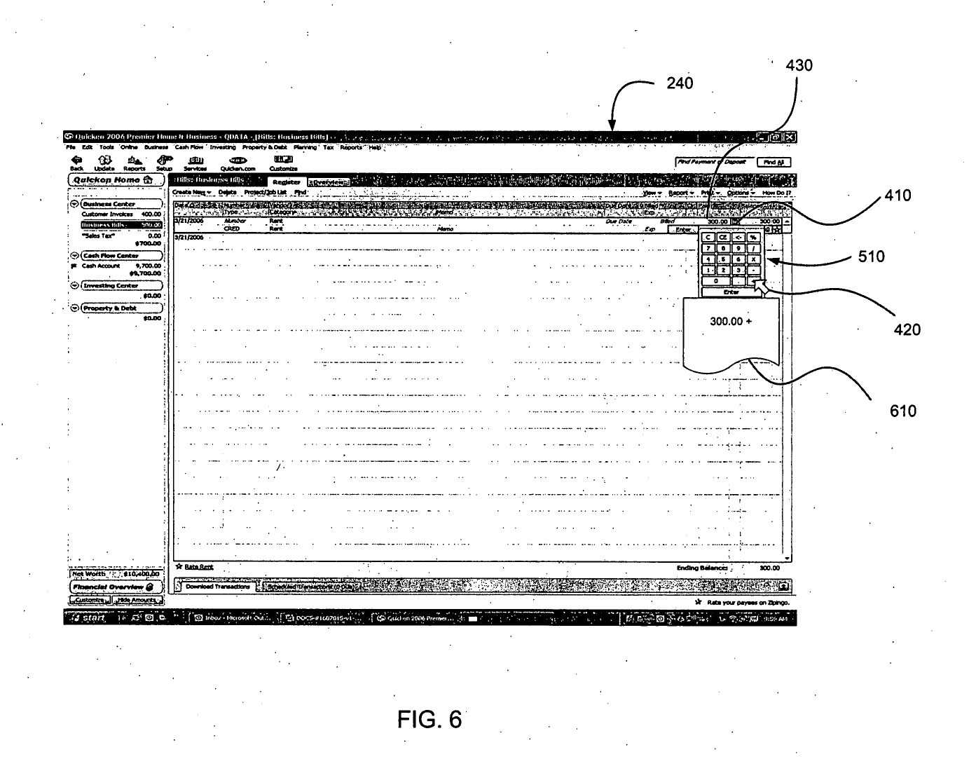

The method begins with receiving user input 110. In response to receiving certain types of user input, a calculation tool 510 is displayed 120. The receipt of user input 110 takes various forms. In one embodiment, the calculation tool 510 is displayed 120 when a user enters one number followed by an arithmetic operator in a form field, indicating that the user is typing an arithmetic calculation, as shown in FIG. 6. In another embodiment, the user input takes the form of a user clicking on an icon 410 within or adjacent to a form field associated with the calculation tool 510, as shown in FIG. 5. Various types of user action might cause the calculation tool 510 to be displayed, such as a mouse click, keyboard selection, mouse hovering, or other input techniques known to those skilled in the art of designing user interfaces, some of which are shown in FIGS. 4-6.

Responsive to any of the above described inputs, or another manner of input according to the embodiments of the present invention, the calculation tool 510 is displayed 120 to the user for entering primary data. The display may take various forms. In one embodiment, the display is in the form of a tool tip, modal or non-modal window, or pop up displaying the calculation tool 510. A portion of a user interface is one means for displaying the calculation tool 510. An example of this type of display is shown in FIG. 5.

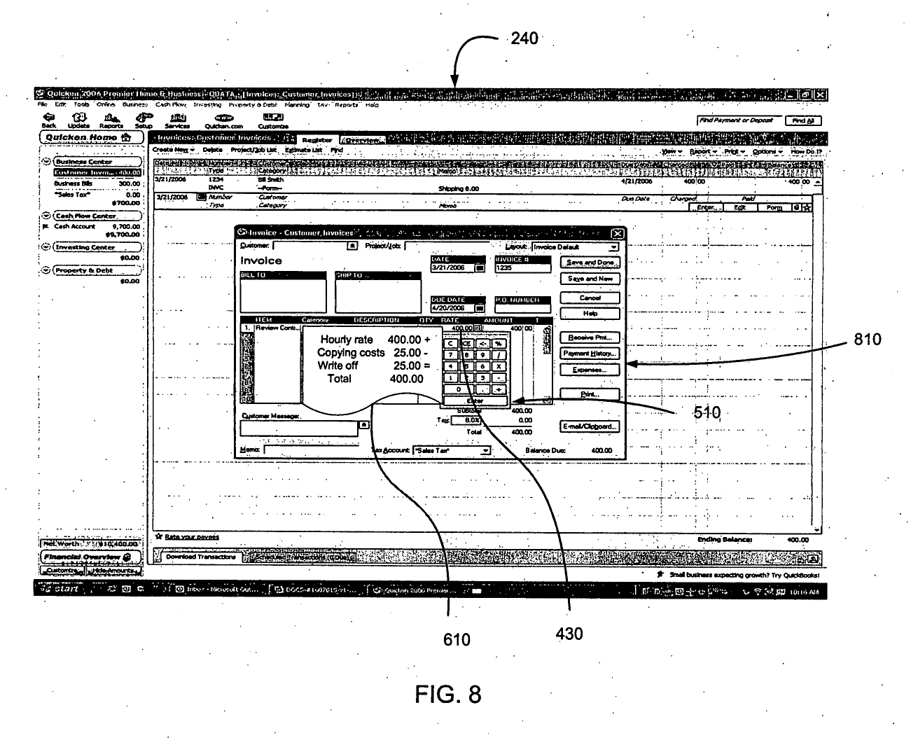

The calculation tool 510 receives the primary data 130 entered by a user concerning a first value entered in a first form field 430. In one embodiment, the primary data includes at least one number and an arithmetic operator, such as for example “400+25”, as shown in FIG. 8.

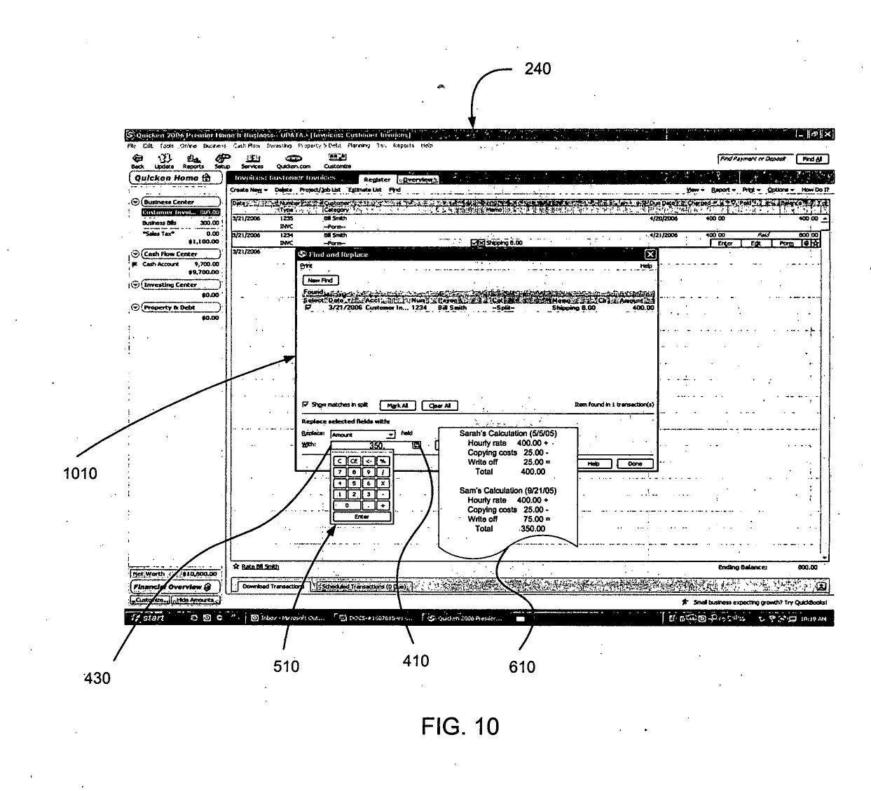

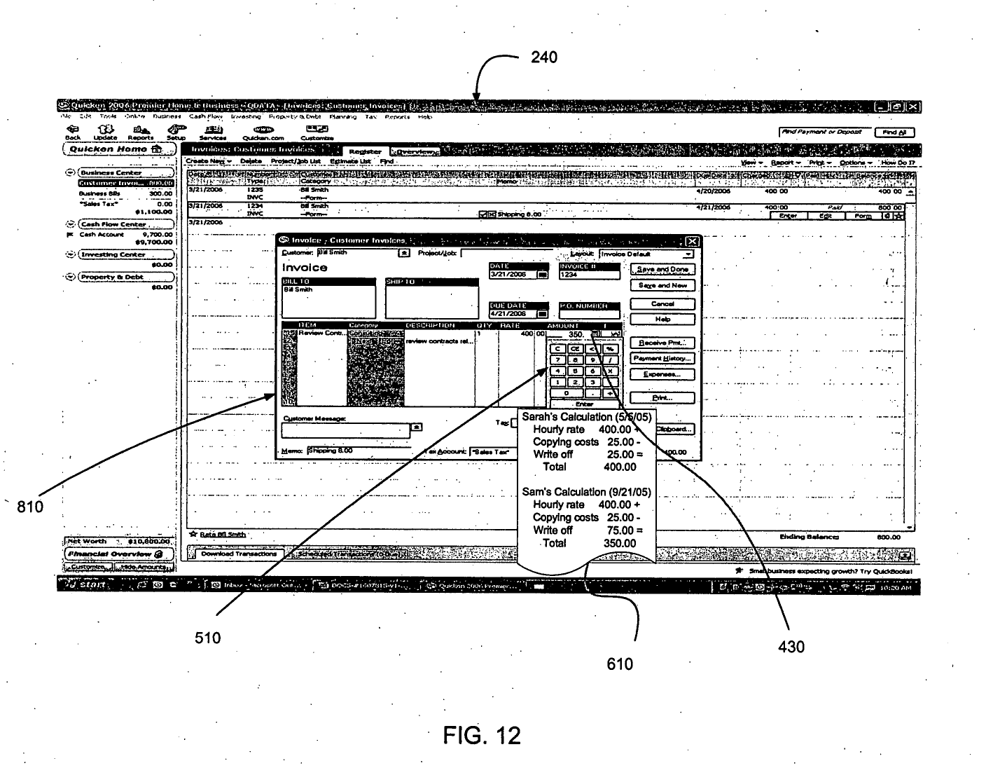

In another embodiment, the primary data concerning the first value includes information about when the primary data was entered and about the author of the primary data, as shown in FIGS. 10 and 12.

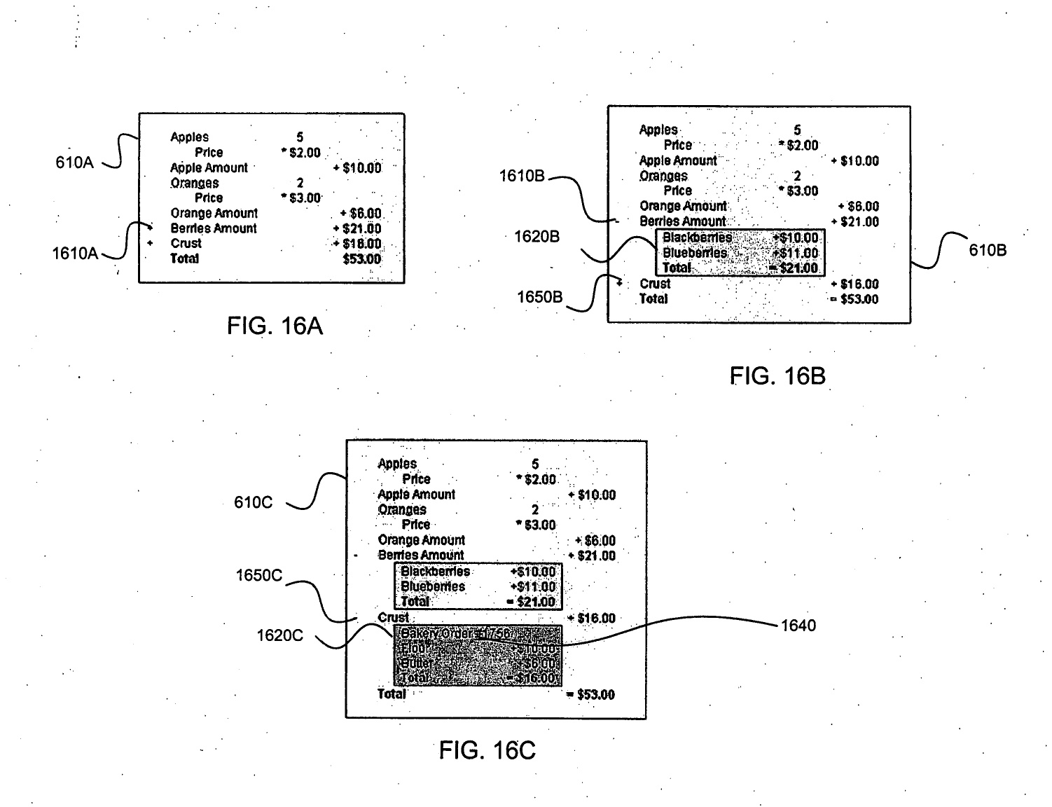

In another embodiment, as shown in FIG. 16C, the primary data includes a link to one or more supporting documents, such as an invoice, picture, pay stub, check, and/or email.

In another embodiment, the primary data concerning the first value includes a second value from a second form field and its associated primary data, as shown in FIGS. 16A-16C. The second value and its associated primary data are used to calculate the first value in the first form field in one embodiment, as shown, for example, in FIGS. 16A-16C. This may be accomplished, for example, by linking to another file or form field containing the second value and its associated primary data.

In another embodiment, the primary data is received by a source other than the user, such as a downloaded transaction from a bank or employer with primary data for a paycheck.

After the primary data received 130 by the calculation tool has been used to calculate 150 the first value in a first form field, as shown for example in FIG. 8, the primary data is stored 140 in a storage mechanism, such as a database, after the user has changed focus to a different form field, according to one embodiment. In one embodiment, the user changes focus by using mouse or keyboard combination, such as a tab, to select a different form field. In another embodiment, the user may indicate that the primary data is to be saved by clicking on an icon representing storage, such as the “Save and Done” button and/or “Enter” button shown in FIG. 8. In one embodiment, the first value is stored 160 in a storage mechanism, such as a database. In another embodiment, the first value is not stored. The first value can be generated at another time in response to user input.

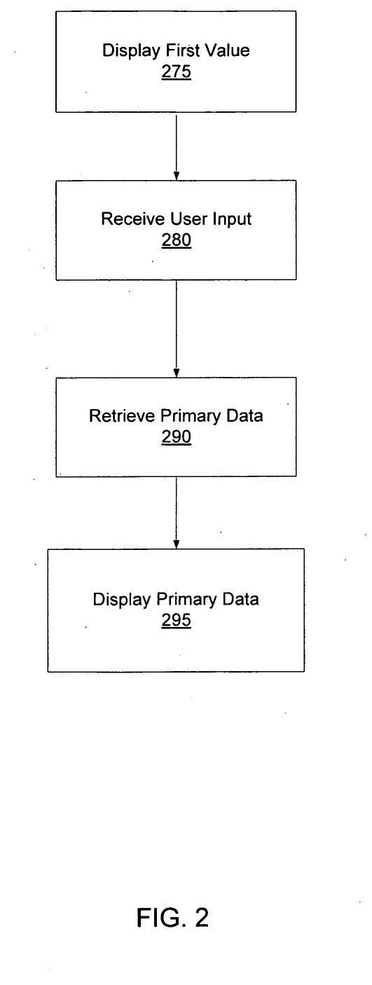

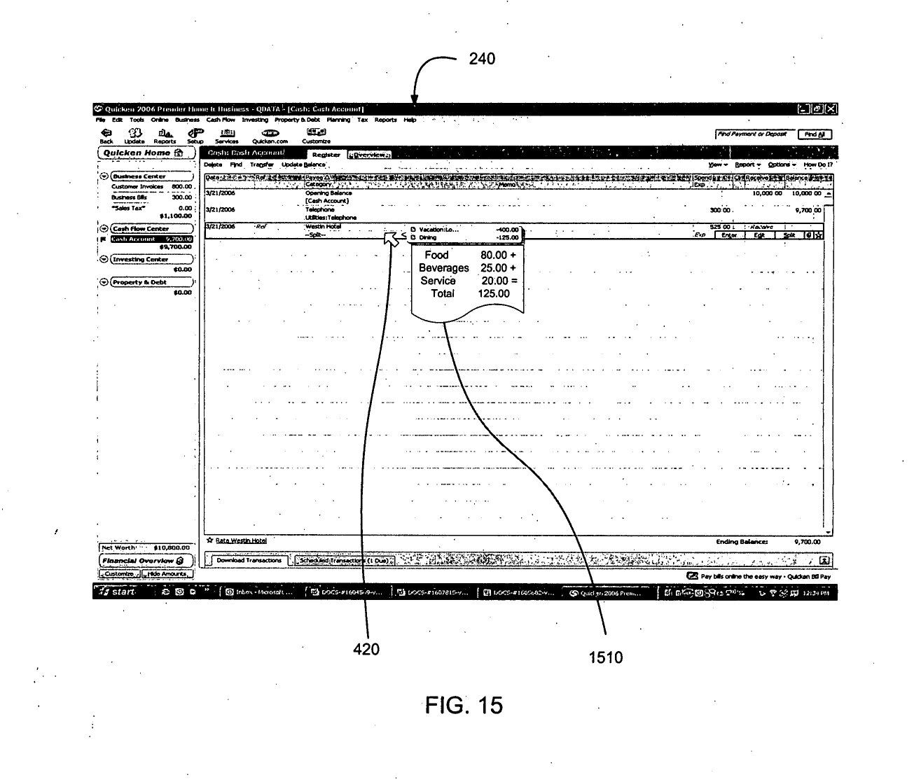

The flowchart of FIG. 2 demonstrates a method for retrieving and displaying the primary data concerning the first value displayed in a first form field. The first value is displayed within a first form field 275, as shown for example in FIG. 8. The primary data is retrieved 290 and displayed 295 in response to user input 280, as shown for example in FIG. 15.

In one embodiment, the primary data concerning the first value is retrieved 290 and displayed 295 by selecting an icon representing the stored primary data concerning the first value. In another embodiment, the primary data concerning the first value is retrieved 290 and displayed 295 by selecting a form field 430 that contains an annotated value. In another embodiment, the primary data is displayed 295 in response to the user hovering over a portion of a form field 430 that contains an annotated value, as shown in FIG. 15. For example, after an annotated value has been entered into a field, hovering over the field displays the primary data without clicking. In another embodiment, the primary data is displayed 295 after a user clicks on a form field 430 that contains an annotated value. The primary data may also be retrieved using any of the other embodiments of user input described with reference to step 110 of FIG. 1, and/or other techniques.

In one embodiment, the primary data may be displayed 295 without the calculation tool 510 being displayed. In another embodiment, the primary data is retrieved 290 when the user selects an icon 410 representing the calculation tool 510, resulting in the display 120 of the calculation tool 510, such that the primary data is retrieved 290 and displayed 295 concurrently with the display 120 of the calculation tool 510. For example, in FIG. 15, the primary data is displayed when the user hovers over the transaction.

The context in which the primary data is displayed may be different from that in which it was entered. For example, the user could hover over a graphical element in a chart and view the primary data in a pop-up window, where the primary data was initially entered in a form field. In addition, where the primary data was received electronically from someone other than the user, such as a bank or an employer, the data could be displayed in the same way as if it were input by the user. In another embodiment, the data that was not received from the user could be displayed in a different format than that received by the user.

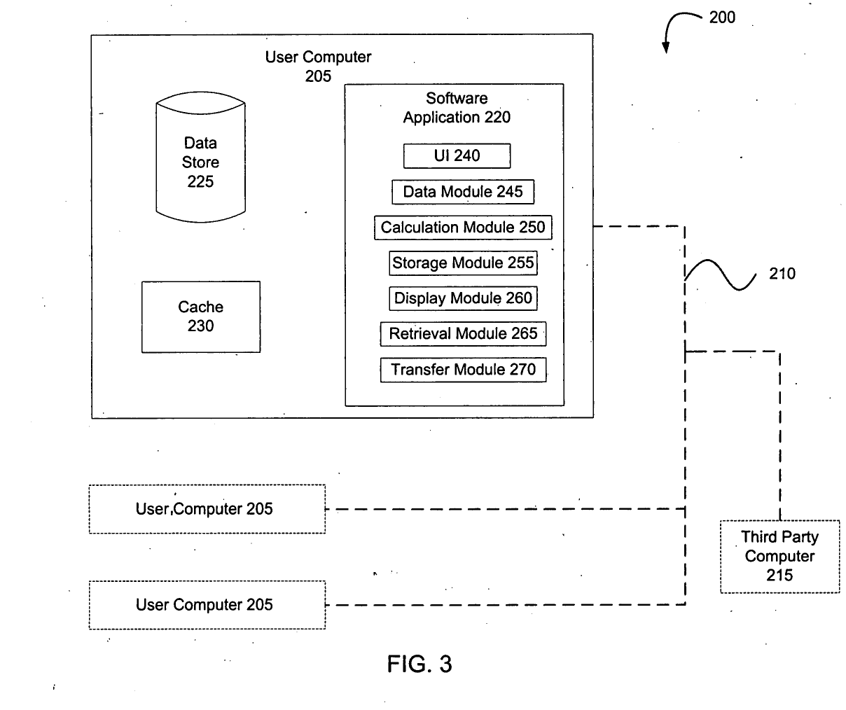

FIG. 3 is a block diagram illustrating the architecture of one embodiment of a system 200 useful for supporting a software application 220 for annotating values. In such a system 200, there is provided at least one user computer 205, which may be a stand-alone device or may be communicatively coupled to a network 210 and/or one or more third party computers 215, as indicated by dotted lines.

The user computer 205 is of conventional design, and includes a processor, an addressable memory, and other conventional features (not illustrated) such as a display, local memory, input/output ports, and a network interface. In other embodiments one or more of the components of the user computer 205 may be located remotely and accessed via a network, e.g., 210. The network interface and a network communication protocol provide access to a network 210 and other computers, such as other user computers 205 or third party computers 215, along with access to the Internet, via a TCP/IP type connection, or to other network embodiments, such as a LAN, a WAN, a MAN, a wired or wireless network, a private network, a virtual private network, or other networks. In various embodiments the user computer 205 may be implemented on a computer running a Microsoft operating system, Mac OS, various flavors of Linux, UNIX, Palm OS, and/or other operating systems.

The third party computers 215, if present, also may be computer systems, similar to the user computer described above. For example, one embodiment of a third party computer 215 is a financial institution computer system, which provides transactions processing and clearing functionality for user software. The financial institution could be a securities brokerage company, a bank or credit union, a credit card company, or financial institutions. In this embodiment, the user software application 220 described herein may be a financial management software package capable of communicating with the financial institution computer system to access information from pre-existing user accounts (e.g., obtain account balances to determine available funds), and provide payment instructions for making payments to vendors.

The user computer 205 includes a software application 220, data store 225, and data cache 230. The software application 220 is comprised of a number of executable code portions and data files. These include code for creating and supporting a user interface 240 according to one embodiment of the present invention, as well as for supporting a method of annotating values within a form field and/or retrieving annotated values. In other embodiments, the software application 220 can also be implemented as a stand-alone application outside of a financial management software package.

The software application 220 is responsible for orchestrating the processes performed according to the methods of the present invention. The software application 220 includes a data module 245, a calculation module 250, a storage module 255, a display module 260, a retrieval module 265, and a transfer module 270 according to one embodiment of the present invention.

The data module 245 enables the system 200 to receive user input to display the calculation tool 510, and is one means for so doing according to one embodiment. In addition, the data module 245 enables the system 200 to receive the primary data about the values within the form fields in one embodiment, and is one means for so doing. In one embodiment, the displaying is as described in conjunction with steps 110, 130 and 280, of FIGS. 1 and 2.

The calculation module 250 enables the calculation tool 510 to perform an arithmetic operation based on the primary data. The calculation module 250 also enables the calculation tool 510 to associate, for example, comments, links to supporting documents, email messages, invoices or other information to the primary data in one embodiment, and is one means for so doing. In one embodiment, performing the calculation is as described in conjunction with step 150 of FIG. 1.

The storage module 255 enables the system 200 to store the values within the form fields and their associated primary data in one embodiment, and is one means for so doing. In one embodiment, the storing is as described in conjunction with steps 140 and 160 of FIG. 1.

The display module 260 enables the system 200 to display the calculation tool 510 as well as the stored values and their associated primary data, and is one means for so doing. In one embodiment, the displaying is as described in conjunction with steps 120 and 295 of FIGS. 1 and 2.

The retrieval module 265 enables the system 200 to retrieve the stored values and their associated primary data, and is one means for so doing. In one embodiment, the retrieving is as described in conjunction with step 290 of FIG. 2.

The transfer module 270 enables the system 200 to incorporate a second value from a second form field and its associated primary data for use in calculating a first value in a first form field in one embodiment, and is one means for so doing. The incorporation of the second value and its associated primary data is described in more detail below with reference to FIGS. 16A-16C.

The above software portions 245-255 need not be discrete software modules. The software configuration shown is meant only by way of example; other configurations are contemplated by and within the scope of the present invention.

The software application 220 may be provided to the user computer 205 on a computer readable media, such as a CD-ROM, diskette, or by electronic communication over the network 210 from one of the third party computers 215 or other distributors of software, for installation and execution thereon. Alternatively, the software application 220, data store 225, and data cache 230 can be hosted on a server computer, and accessed over the network 210 by the user, using for example a browser interface to the software application 220.

The data store 225 may be a relational database or any other type of database that stores the data used by the software application 220, for example account information in the financial management application embodiment referenced above. The data store 225 may be accessible by the software application 220 through the user interface 240. Some data from the data store 225 may be added to the data cache 230 upon initialization of the software application 220. The software application 220 and the data store 225 may be stored and operated on a single computer or on separate computer systems communicating with each other through a network 210.

The data cache 230 is a standard cache of small, fast memory holding recently accessed data. The data cache 230 may include, for example, one or more lists of elements according to one embodiment of the present invention.

One skilled in the art will recognize that the system architecture illustrated in FIG. 3 is merely exemplary, and that the invention may be practiced and implemented using many other architectures and environments.

In the embodiment shown in the following figures, the user interface 240 is provided as part of a financial management software application, a portion of which is shown in figures. In other embodiments, user interface 240 associated with other types of applications are used. The particular screen layouts, appearance, and terminology as depicted and described herein, are intended to be illustrative and exemplary, and in no way limit the scope of the invention as claimed.

FIG. 4 is a screenshot illustrating a user interface 240 of a financial management software product for requesting a user-manipulable calculation tool 510 according to one embodiment. In FIG. 4, the cursor 420 is positioned over a calculator icon 410 located within form field 430 of a transaction register, the calculator icon 410 representing the user-manipulable calculation tool 510, according to one embodiment. In one embodiment, the user requests that the calculation tool 510 be displayed by clicking, double-clicking or right clicking the icon 410 as shown in FIG. 4. In another embodiment, the user requests that the calculation tool 510 be displayed by clicking, double-clicking or right clicking the form field 430.

In FIG. 5, the calculation tool 510 is displayed within the context of a transaction register in response to user input, as set forth in steps 110-120 of FIG. 1. Although the user-manipulable calculation tool 510 resembles a calculator in FIG. 5, one of skill in the art of designing user interfaces would recognize that the calculation tool 510 could take a variety of forms other than those shown in the Figures. In one embodiment, the calculation tool 510 allows for entering numerals and arithmetic operations, as shown in FIGS. 6, 8, 10, 12, 14 and 16A-16C. In one embodiment, the calculation tool 510 allows for entry of text, graphics, links to various media and documents, and/or links to annotated values within other form fields (in the same or different documents), as shown for example in FIGS. 8, 10, 12, 14, and 16A-16C.

As shown in FIG. 6, the calculation tool 510 is displayed after the user enters at least one number and an arithmetic operator within form field 430 of a transaction register, according to one embodiment. In one embodiment, the primary data concerning the first value entered within the form field 430 is displayed concurrently with the entry of the primary data into form field 430, as shown in FIG. 6. One skilled in the art will recognize that the display 610 of the primary data is not limited to that depicted in FIG. 6. For example, the display of primary data could be located within a pop up, a window, a margin, or virtually anywhere on the screen.

In another embodiment, the primary data concerning the first value entered within the form field is not displayed concurrently with the entry of the primary data into form field 430.

One skilled in the art would recognize that the techniques of the present invention can be used in various contexts other than a transaction register. For example, the present invention would be well suited for use in an invoice, where the user might not want to share primary data about invoice values with the recipient of the invoice, but the user would want to have the primary data available for future reference.

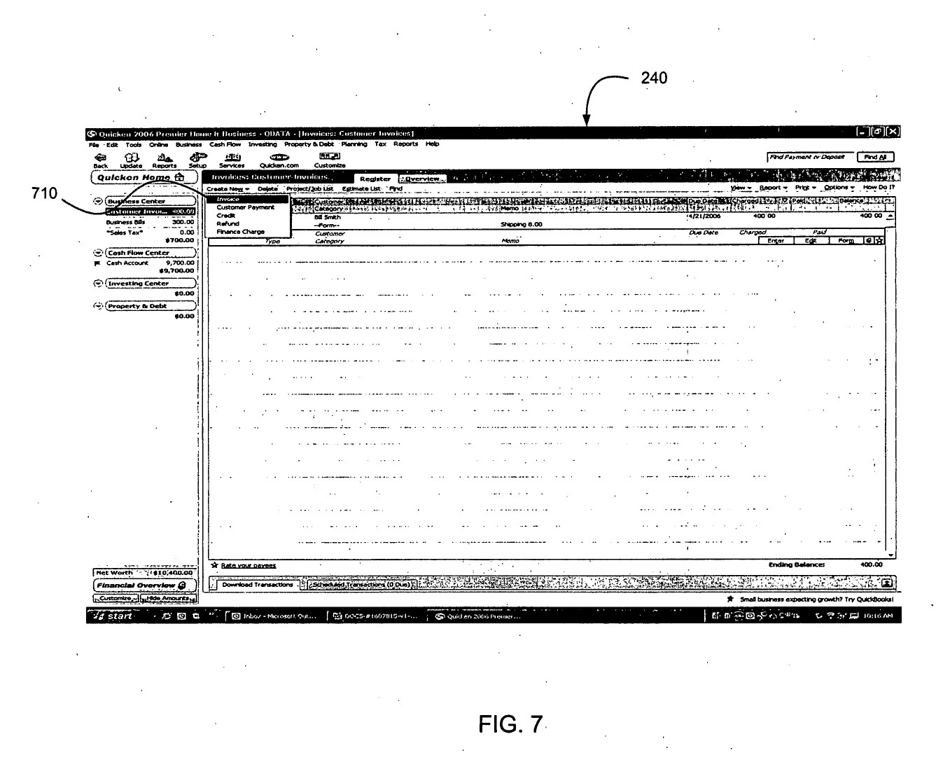

For example, in FIG. 7, a request for a new invoice from a drop down menu 710 results in invoice window 810, as displayed in FIG. 8. As shown in FIG. 8, primary data concerning a value within a form field 430 can be entered into the calculation tool 510, according to one embodiment. In one embodiment, the primary data includes notes about the numerals entered, as shown in FIG. 8. Although the primary data is displayed within a window 610 concurrently with the entry of the primary data in FIG. 8, the primary data need not be displayed at the same time as it is entered.

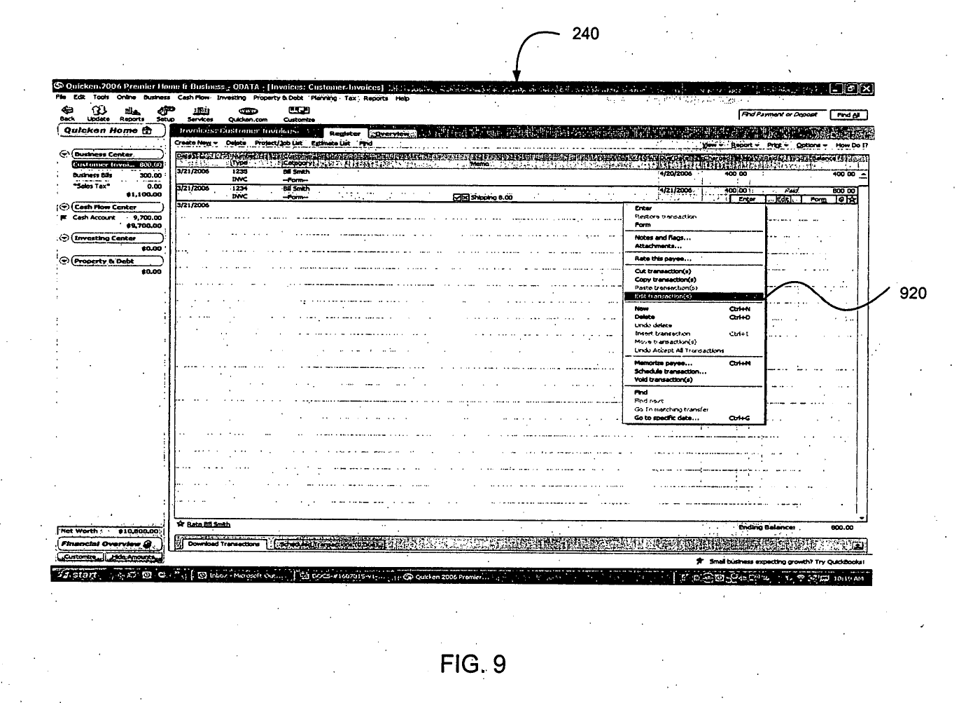

The user may edit the primary data previously entered in the user-manipulable calculation tool 510 concerning a first value entered within a first form field. In FIG. 9, a request to edit a transaction is selected from a drop down menu 920, according to one embodiment of the present invention. In response to the request of FIG. 9, window 1010 is displayed, as shown in FIG. 10. In response to user input, as the primary data is retrieved 290 and displayed 295, according to one embodiment.

In another embodiment, the user can click on the displayed primary data to edit the primary data or utilize a keyboard selection to select the displayed primary data and edit it. In another embodiment, the user can select the form field or an icon 410 within the form field representing the user-manipulable calculation tool 510 to edit the primary data.

The edit to the primary data is stored. In one embodiment, the edit is stored using storage techniques similar to those described above. In one embodiment, the edit to the primary data is stored in addition to the original primary data, such that both are retained separately. In another embodiment, only the edit to the primary is stored, replacing the original primary data. In another embodiment, the edit to the primary data changes only the portion of the primary data specified, such that the changes to the primary data are tracked with different formatting from the original primary data entered. In another embodiment, a revision history is maintained, so as to enable a user to determine what edits were made, who made the edits, and when they were made. The revision history also allows a user to undo edits if he or she wishes to restore the data to a previous state.

A calculation based on the edited primary data results in an edited value, which is then stored. In one embodiment, the calculation and/or storage are carried out using techniques similar to those described above. In one embodiment, the edited value is stored in addition to the original value, such that both are retained, as is shown in FIG. 10. In another embodiment, only the edited value is stored, replacing the original primary data.

The edited value is displayed in the first form field, according to one embodiment. In one embodiment, the edited value is displayed using techniques similar to those described above. In one embodiment, only the edited value is displayed in the first form field.

In another embodiment, the original and edited values are both displayed in the first form field. In one embodiment, the original and edited values may be displayed in different colors. In another embodiment, the original and primary values may be distinguished by a space, comma, line, period, graphic, letter, slash, font style, or a hard return within the form field.

In response to user input, the edited primary data is retrieved and displayed. In one embodiment, the primary data is retrieved and displayed using techniques similar to those described above. In one embodiment, only the edited primary data is retrieved and displayed. In another embodiment, both the original and edited primary data are retrieved and displayed. In another embodiment, the revision history of the primary data is retrieved and made available for display. For example, changes to the primary data can be shown with different formatting from the original primary data entered.

In one embodiment, display 610 shows the edited primary data concurrent with the user entering it. In another embodiment, the display 610 shows only the original primary data while the edited primary data is being entered. In another embodiment, the display 610 is not present. In another embodiment, the display 610 is shown responsive to user input. In another embodiment, the revision history is displayed responsive to user input, such as selecting a link or an icon representing the revision history. Revised data may be shown in a different color than original data, or it can be formatted differently, or it can be distinguished in some other way. The user may also be given the opportunity to selectively undo previously-made edits and thereby restore the data to a previous state, if desired.

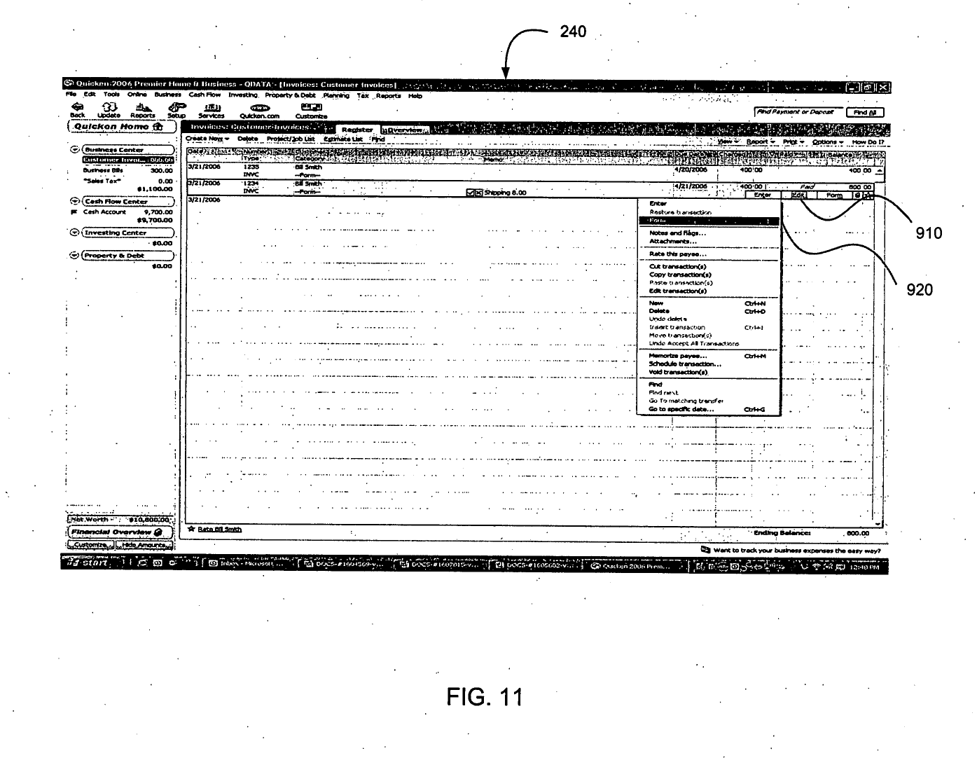

In FIG. 11, a request to edit a form is selected from a drop down menu 920. In response to the request of FIG. 11, invoice window 810 is displayed, as shown in FIG. 12. Unlike FIG. 8, which shows the original primary data being entered, the user enters the edited primary data in FIG. 12. In response to user input, as described above with respect to step 280 of FIG. 2, the original primary data is retrieved 290 and displayed 295, according to one embodiment.

In another embodiment, the user can click on the displayed primary data to edit the primary data or utilize a keyboard selection to select the displayed primary data and edit it. In another embodiment, the user can select the form field or an icon 410 within the form field representing the user-manipulable calculation tool 510. In another embodiment, the edits to the primary data are entered with distinctive formatting to track the changes in the display as they are entered.

As described above with respect to FIG. 10, the edit to the primary data is stored, a calculation based on the edited primary data results in an edited value, which is then stored. As with FIG. 10, the edited value is displayed in the first form field, according to one embodiment.

In response to user input, the edited primary data is retrieved and displayed. In one embodiment, the edited primary data is retrieved and displayed using techniques similar to those described above. In one embodiment, only the edited primary data is retrieved and displayed. In another embodiment, both the original and edited primary data are retrieved and displayed.

In one embodiment, display 610 shows the edited primary data concurrent with the user entering it. In another embodiment, the display 610 shows only the original primary data while the edited primary data is being entered. In another embodiment, the display 610 is not present. In another embodiment, the display 610 is shown responsive to user input. In another embodiment, the revision history is displayed responsive to user input, such as selecting a link or an icon representing the revision history.

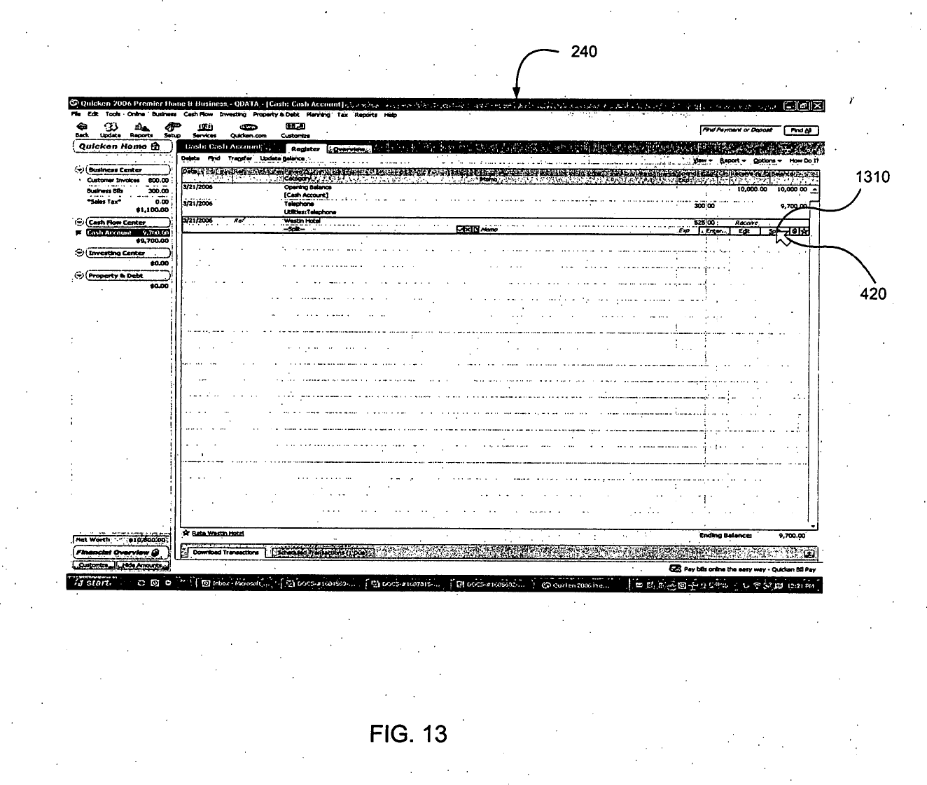

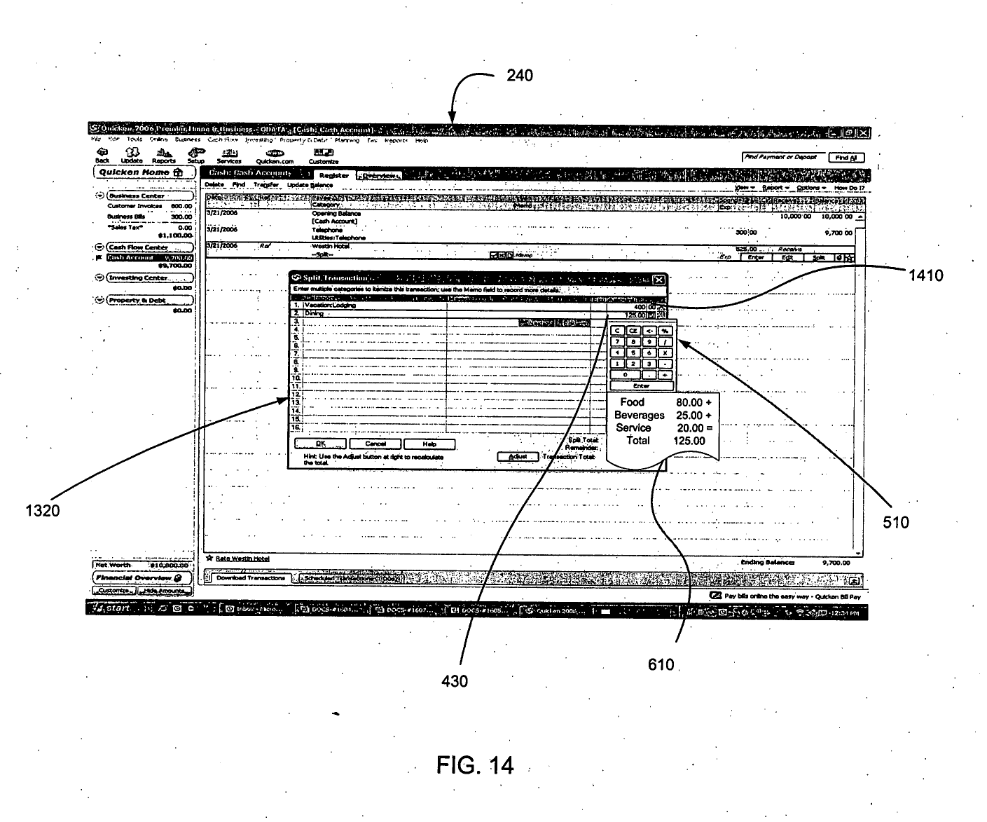

FIG. 13 is a screenshot of one embodiment of a user interface of a financial management software product for requesting a split of a transaction. By positioning cursor 420 over the graphical user interface “split” button, or utilizing a keyboard to select the same, the user can enter data within form field 430 of window 1320 of FIG. 14.

After splitting the transaction among different categories, a user can annotate the values set forth in the split, as shown in display 610 of FIG. 14. In one embodiment, display 610 is shown concurrently with the entry of primary data into form field 430. In another embodiment, display 610 is shown in response to user input.

In FIG. 15, the primary data is displayed regarding the split transaction of FIG. 14, in one embodiment. When cursor 420 hovers over the split transaction, display 1510 appears, containing the values that constitute the split transaction as well as their annotations, in one embodiment. When cursor 420 is moved from the split transaction, in one embodiment, display 1510 is no longer visible. In another embodiment, a graphical user interface, such as an “x-box” can be clicked to remove the display 1510. In another embodiment, only the values constituting the split are shown in response to cursor 420 hovering, unless additional user input is received requesting display of the primary data associated with the values. One skilled in the art will recognize that similar types of displays to those described with reference to FIG. 15 could be used for displaying primary data associated with any transaction, including where the transaction is not split.

FIGS. 16A-16C are illustrations of embodiments of a user interface of a financial management software product displaying annotated values in the context of a transaction register. In one embodiment, the displays 610A-C shown in FIGS. 16A-C are similar to those with reference numeral 610 shown in FIGS. 6, 8, 10, 12, 14 and 15.

Displays 610A-C show primary data regarding certain values, according to one embodiment. In one embodiment, the “Total” amount of $53.00 in FIG. 16A is a value entered into a form field. The other numbers that are used to calculate the $53.00 total, as well as the arithmetic operations and words associated therewith, are the primary data concerning the value of $53.00, according to one embodiment.

Another example of primary data, the “+Berries Amount” shown in FIG. 16A, incorporates information from another form field, which can be transferred in from the same form or another form. As seen in FIG. 16B, the ““+Berries Amount” can be expanded to display the “transferred in” primary data and associated value from another form field, which in this example is shown in box 1620B. Thus, in one embodiment, the plus sign “+” 1610A can be selected and expanded to display the “transferred in” primary data and associated value from another form field, as is shown in FIGS. 16A and 16B. After the plus sign “+” 1610A is selected to display the additional data box 1620B, the display changes to a minus sign “−” 1610B. One skilled in the art of user interface design would recognize multiple techniques for indicating this expanded view.

In another embodiment, the primary data includes a link 1640 to a supporting document, such as an invoice, email, pay stub, voicemail, receipt, letter, file, facsimile, photograph, or other document, as shown in FIG. 16C.

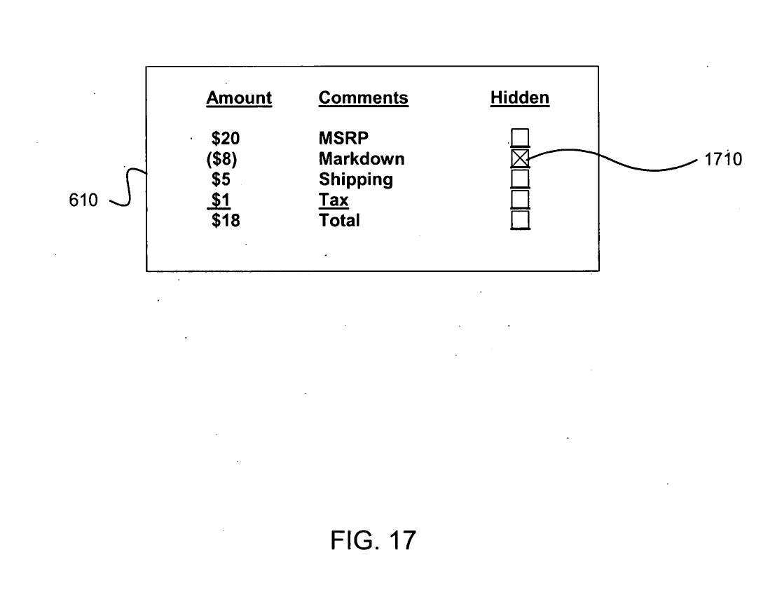

FIG. 17 is an illustration of one embodiment of a user interface of a financial management software product for specifying whether certain information about certain values is to be hidden. In one embodiment, the display 610 shown in FIG. 17 is similar to those with reference numeral 610 shown in FIGS. 6, 8, 10, 12, and 14-16C. As shown in FIG. 17, the user specifies whether certain primary data is to be made visible during subsequent displays of the data by checking box 1710, according to one embodiment.

In one embodiment, the user limits the display of specified primary data based on the identity of the viewer. In another embodiment, the user limits the display of the specified data based on the medium in which the display is presented, such as digitally or in print. In another embodiment, the user limits the data displayed to the numerals and arithmetic operations, keeping the comments hidden. In another embodiment, the use of password protection ensures only certain users with the appropriate password have access to the hidden data. One skilled in the art will recognize that the methods of determining whether data will be displayed described with reference to FIG. 17 are exemplary, and that various other methods may be used in carrying out the present invention.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method of annotating values, comprising:
in response to user input, displaying a user-manipulable calculation tool related to a first value within a first form field;
receiving primary data concerning the first value entered in the user-manipulable calculation tool; and
storing the primary data concerning the first value in response to a user action.

2. The method of claim 1, wherein the user input comprises at least one selected from the group consisting of:
selecting the first form field;
positioning a selection tool over the first form field;
entering primary data within the first form field;
selecting a user-interface icon representing the calculation tool; and
selecting a link to the calculation tool within the first form field.

3. The method of claim 1, wherein the primary data comprises at least one number and at least one arithmetic operator.

4. The method of claim 3, wherein the primary data concerning the first value further comprises at least one selected from the group consisting of:
a title;
a note;
a link to a supporting document;
a date the primary data concerning the first value was entered;
a time the primary data concerning the first value was entered;
identifying information of at least one author of the primary data concerning the first value; and
an annotated value stored in a second form field, wherein the annotated value comprises a second value and primary data concerning the second value, wherein the primary data concerning the second value has been used to perform a calculation, the calculation resulting in the second value, the second value stored in the second form field.

5. The method of claim 4, wherein the supporting document comprises at least one selected from the group consisting of:
a receipt;
a letter;
an invoice;
a note;
a file;
a facsimile;
an email; and
a pay stub.

6. The method of claim 1, wherein the user action comprises at least one selected from the group consisting of:
changing focus away from the first form field;
positioning a selection tool over a second form field;
entering primary data within the second form field;
selecting a user-interface icon representing the calculation tool in a second form field;
selecting a link to the calculation tool within the second form field;
selecting a user-interface icon representing a “save” function within the first form field;
selecting a user-interface icon representing a “save” function within the user-manipulable calculation tool.

7. The method of claim 1, further comprising:
performing a calculation specified by the primary data, the calculation resulting in the first value; and
storing the first value in the first form field.

8. A computer-implemented method of reviewing annotated values, comprising:
displaying a first value in a first form field;
in response to user input, retrieving primary data concerning the first value, wherein the primary data has been used to perform a calculation, the calculation resulting in the first value, the first value stored in the first form field; and
displaying the primary data.

9. The method of claim 8 wherein the user input comprises at least one selected from the group consisting of:
selecting the first form field;
positioning a selection tool over the first form field;
entering primary data within the first form field;
selecting a user-interface icon representing a calculation tool; and
selecting a link to the calculation tool within the first form field.

10. The method of claim 8, wherein the primary data comprises at least one number and at least one arithmetic operator.

11. The method of claim 10, wherein the primary data concerning the first value further comprises at least one selected from the group consisting of:
a title;
a note;
a link to a supporting document;
a date the primary data concerning the first value was entered;
a time the primary data concerning the first value was entered;
identifying information of at least one author of the primary data concerning the first value; and
an annotated value from a second form field, wherein the annotated value comprises a second value and primary data concerning the second value, wherein the primary data concerning the second value has been used to perform a calculation, the calculation resulting in the second value, the second value stored in the second form field.

12. The method of claim 11, wherein the supporting document comprises at least one selected from the group consisting of:
a receipt;
a letter;
an invoice;
a note;
a file;
a facsimile;
an email; and
a pay stub.

13. The method of claim 8, wherein displaying the primary data comprises displaying the primary data that has been specified.

14. The method of claim 8, wherein the primary data is displayed in a printed media.

15. The method of claim 14, wherein the primary data displayed comprises the primary data that has been specified.

16. The method of claim 8, further comprising:
in response to user input, displaying a calculation tool;
receiving an edit to the primary data entered in the user-manipulable calculation tool;
storing the edit to the primary data;
performing an edited calculation specified by the edit to the primary data, the edited calculation resulting in an edited value; and
storing the edited value in the first form field.

17. The method of claim 16, further comprising:
displaying the edited value in the first form field;
in response to user input, retrieving the edit to the primary data; and
displaying the edit to the primary data.

18. The method of claim 16, further comprising:
displaying the edited value in the first form field;
in response to user input, retrieving a revision history of the primary data; and
displaying the revision history of the primary data.

19. A computer-implemented method of annotating values, comprising:
in response to user input, displaying a user-manipulable calculation tool related to a first value within a first form field;
receiving primary data concerning the first value entered in the user-manipulable calculation tool;
storing the primary data concerning the first value in response to a user action;
displaying the first value in the first form field;
in response to user input, retrieving the primary data concerning the first value; and
displaying the primary data concerning the first value.

20. The method of claim 19, wherein the user input comprises at least one selected from the group consisting of:
selecting the first form field;
positioning a selection tool over the first form field;
entering primary data within the first form field;
selecting a user-interface icon representing a calculation tool; and
selecting a link to a calculation tool within the first form field.

21. The method of claim 19, wherein the primary data comprises at least one number and at least one arithmetic operator.

22. The method of claim 21, wherein the primary data concerning the first value further comprises at least one selected from the group consisting of:
a title;
a note;
a link to a supporting document;
a date the primary data concerning the first value was entered;
a time the primary data concerning the first value was entered;
identifying information of at least one author of the primary data concerning the first value; and
an annotated value stored in a second form field, wherein the annotated value comprises a second value and primary data concerning the second value, wherein the primary data concerning the second value has been used to perform a calculation, the calculation resulting in the second value, the second value stored in the second form field.

23. The method of claim 22, wherein the supporting document comprises at least one selected from the group consisting of:
a receipt;
a letter;
an invoice;
a note;
a file;
a facsimile;
an email; and
a pay stub.

24. The method of claim 19, wherein displaying the primary data comprises displaying the primary data that has been specified.

25. The method of claim 19, wherein the primary data is displayed in a printed media.

26. The method of claim 25, wherein the primary data displayed comprises the primary data that has been specified.

27. The method of claim 19, further comprising:
performing a calculation specified by the primary data concerning the first value, the calculation resulting in the first value; and
storing the first value in the first form field.

28. The method of claim 27, further comprising:
in response to user input, displaying the user-manipulable calculation tool;
receiving an edit to the primary data entered in the user-manipulable calculation tool;
storing the edit to the primary data;
performing an edited calculation specified by the edit to the primary data, the edited calculation resulting in an edited value; and
storing the edited value in the first form field.

29. The method of claim 28, further comprising:
displaying the edited value in the first form field;
retrieving the edit to the primary data in response to user input; and
displaying the edit to the primary data.

30. The method of claim 28, further comprising:
displaying the edited value in the first form field;
in response to user input, retrieving a revision history of the primary data; and
displaying the revision history of the primary data.

31. The method of claim 19, wherein the user action comprises at least one selected from the group consisting of:
changing focus away from the first form field;
positioning a selection tool over a second form field;
entering primary data within the second form field;
selecting a user-interface icon representing the calculation tool in a second form field;
selecting a link to the calculation tool within the second form field;
selecting a user-interface icon representing a “save” function within the first form field;
selecting a user-interface icon representing a “save” function within the user-manipulable calculation tool.

32. A computer program product for entering and reviewing annotated values, comprising:
a computer-readable medium; and
computer program code, encoded on the medium, for:
displaying a user-manipulable calculation tool related to a first value within a first form field in response to user input;
receiving primary data concerning the first value entered in the user-manipulable calculation tool;
storing the primary data concerning the first value in response to a user action;
displaying the first value in the first form field;
retrieving the primary data concerning the first value in response to user input; and
displaying the primary data concerning the first value.

33. The computer program product of claim 32, wherein the primary data comprises at least one number and at least one arithmetic operator.

34. The computer program product of claim 33, wherein the primary data concerning the first value further comprises at least one selected from the group consisting of:
a title;
a note;
a link to a supporting document;
a date the primary data concerning the first value was entered;
a time the primary data concerning the first value was entered;
identifying information of at least one author of the primary data concerning the first value; and
an annotated value stored in a second form field, wherein the annotated value comprises a second value and primary data concerning the second value, wherein the primary data concerning the second value has been used to perform a calculation, the calculation resulting in the second value, the second value stored in the second form field.

35. The computer program product of claim 32, further comprising:
performing a calculation specified by the primary data concerning the first value, the calculation resulting in the first value; and
storing the first value in the first form field.

36. The computer program product of claim 32, further comprising:
displaying the user-manipulable calculation tool in response to user input;
receiving an edit to the primary data entered in the user-manipulable calculation tool;
storing the edit to the primary data;
performing an edited calculation specified by the edit to the primary data, the edited calculation resulting in an edited value; and
storing the edited value in the first form field.

37. The computer program product of claim 36, further comprising computer program code for:
displaying the edited value in the first form field;
retrieving the edit to the primary data in response to user input; and
displaying the edit to the primary data.

38. The computer program product of claim 36, further comprising computer program code for:
displaying the edited value in the first form field;
retrieving a revision history of the primary data in response to user input; and
displaying the revision history of the primary data.

39. A system for annotating values, comprising:
a user interface module, for displaying a user-manipulable calculation tool related to a first value within a first form field in response to user input;
a data module, for receiving primary data for the first form field;
a calculation module for, responsive to the entry of the primary data, calculating a first value; and
a storage module, for storing the primary data concerning the first value.

40. The system of claim 39, further comprising:
a display module, for displaying the first value in the first form field; and
a retrieval module, for retrieving the primary data concerning the first form field in response to user input; and wherein the display module is configured to display the retrieved primary data concerning the first value in the first form field.

41. The system of claim 40, further comprising:
a transfer module, for transferring in a second value from a second form field and the primary data concerning the second value.

42. A computer readable memory storing a computer program executable by a processor, the computer program producing a user interface of a system for annotating values, the user interface comprising:
a first display area for listing a first value within a first form field; and
a second display area, visually distinguished from and concurrently displayed with the first display area in response to user input, for receiving primary data concerning the first value.

43. The computer program product of claim 42, where the computer program stored on the computer readable medium further comprises:
an executable process that responds to the primary data entered in the second display area to calculate the first value in the first display area.

44. The computer program product of claim 42, wherein the first display area is configured to list a second value within a second form field.

45. The computer program product of claim 42, the user interface further comprising:
a third display area, visually distinguished from and concurrently displayed with the first display area in response to user input, for displaying the primary data concerning the first value.

46. The computer program product of claim 45, the user interface further comprising:
a fourth display area, concurrently displayed with the first and third display areas in response to user input, for displaying a revision history of the primary data.

47. The computer program product of claim 46, wherein the fourth display area is visually distinguished from the first display area.

48. The computer program product of claim 42, wherein the user input comprises at least one selected from the group consisting of:
selecting the first form field;
positioning a selection tool over the first form field;
entering primary data within the first form field;
selecting a user-interface icon representing the calculation tool; and
selecting a link to the calculation tool within the first form field.

49. A computer readable memory storing a computer program executable by a processor, the computer program producing a user interface of a system for annotating values, the computer program comprising:
means for receiving primary data concerning a first value within a first form field;
means for storing the primary data concerning the first value;
means for populating the first form field based on a calculation specified by the primary data; and
means for displaying the first value.

50. The computer program product of claim 49 further comprising:
means for retrieving the stored primary data concerning the first value; and
means for concurrently displaying the first value and the primary data concerning the first value.

51. The computer program product of claim 50 further comprising:
means for transferring in a second value from a second form field and the associated primary data concerning the second value; and
means for concurrently displaying the second value from a second form field and the associated primary data concerning the second value.

52. The computer program product of claim 49 further comprising:
means for editing the primary data concerning a first value within a first form field;
means for storing the edit to the primary data concerning the first value;
means for populating the first form field based on an edited calculation specified by the edited primary data; and
means for storing the edited value.

53. The computer program product of claim 52 further comprising:
means for displaying the edited value in the first form field;
means for retrieving the edit to the primary data; and
means for displaying the edit to the primary data.

54. The computer program product of claim 52 further comprising:
means for displaying the edited value in the first form field;
means for retrieving a revision history of the primary data; and
means for displaying the revision history.
